(19) United States
(12) Patent Application Publication
(10) Pub. No.: US 2009/0088319 A1
(43) Pub. Date: Apr. 2, 2009

(54) Synthesis of Gold Metal Oxide Catalysts for Catalytic Oxidation of Carbon Monoxide by Vapor Deposition of Ammonia

(75) Inventors: Arvind Vyas Harinath, Greensboro, NC (US); Chandra K. Banerjee, Clemmons, NC (US); Jagannathan Sankar, Greensboro, NC (US)

Correspondence Address: MYERS BIGEL SIBLEY & SAJOVEC, PO BOX 37428, RALEIGH, NC, 27627, US

(73) Assignee: North Carolina Agricultural and Technical State University

(21) Appl. No.: 12/240,369

(22) Filed: Sep. 29, 2008

Related U.S. Application Data
(60) Provisional application No. 60/976,046, filed on Sep. 28, 2007.

(51) Int. Cl. B01J 21/02; B01J 23/52; B01J 21/06; B01J 21/10

(52) U.S. Cl. 502/243; 502/344; 502/340

(57) ABSTRACT

The present invention provides processes for synthesizing gold metal oxide catalysts and gold metal oxide catalysts synthesized according to the processes described herein. Methods of using the gold metal catalysts are also provided.

### RELATED APPLICATION DATA

This application claims priority to and the benefit of U.S. Patent Application Ser. No. 60/976,046, filed Sep. 28, 2007, the disclosure of which is incorporated by reference herein in its entirety.

### FIELD OF THE INVENTION

The present invention generally concerns a process for the synthesis of gold metal oxide catalysts.

### BACKGROUND OF THE INVENTION

The synthesis of gold metal oxide catalysts is currently carried out by a treatment employing an aqueous ammonia solution. This process generally involves a significant waste of solution, use of a significant amount of water for cleaning the sample during the process and considerable time required to prepare the sample in general.

The present invention provides a process for the synthesis of gold metal oxide catalysts that can be used to effectively catalyze the oxidation of carbon monoxide to carbon dioxide. The catalysts can be used as catalysts in a wide variety of applications including gas masks, fuel cells and carbon dioxide lasers, for example.

### BRIEF DESCRIPTION OF THE DRAWINGS

FIG. 1. FIG. 1 presents a flow chart showing a conventional process (liquid deposition) of preparing a gold metal oxide catalyst (A) and a process according to the present invention (B).

### SUMMARY OF THE INVENTION

An aspect of the present invention relates to processes for the synthesis of gold metal oxide catalysts including: (a) mixing a metal oxide and a solution of a gold salt; (b) evaporating moisture from the product of (a); (c) reducing the gold salt from (b) to gold hydroxide in the presence of ammonia gas; (d) washing the product remaining after (c) with water; and (e) evaporating moisture from the product remaining after (d) to provide a gold metal oxide catalyst.

Further aspects of the present invention include gold metal oxide catalysts synthesized by the processes described herein.

Additional aspects of the present invention provide processes for the oxidation of carbon monoxide including introducing a gold metal oxide catalyst synthesized by the processes described herein to an environment including carbon monoxide under conditions suitable to support the substantial conversion of carbon monoxide to carbon dioxide.

The processes of synthesizing gold metal oxide catalysts of the present invention may provide an improved process compared to the conventional process of synthesizing gold metal oxide catalysts. These processes allow less waste of solution, provide reduced water usage and/or decreases the time associated with sample preparation. Accordingly, the gold metal oxide catalysts may be employed in a cost-effective, resource-saving and/or time-efficient manner in the oxidation of carbon monoxide for applications including, but not limited to, gas masks, fuel cells and carbon dioxide lasers.

### DETAILED DESCRIPTION

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. As used herein, the term “and/or” includes any and all combinations of one or more of the associated listed items.

Unless otherwise defined, all technical and scientific terms used herein have the same meaning as commonly understood by one of ordinary skill in the art to which this invention belongs.

It will be understood that steps comprising the methods provided herein can be performed independently or at least two steps can be combined when the desired outcome can be obtained.

Embodiments of the present invention provide processes for the synthesis of gold metal oxide catalysts including: (a) mixing a metal oxide and a solution of a gold salt; (b) evaporating moisture from the product of (a); (c) reducing the gold salt from (b) to gold hydroxide in the presence of ammonia gas; (d) washing the product remaining after (c) with water; and (e) evaporating moisture from the product remaining after (d) to provide a gold metal oxide catalyst. In some embodiments, the metal oxide is aluminum oxide, silicon oxide, magnesium oxide, titanium oxide or combinations thereof. In particular embodiments, the metal oxide is aluminum oxide. In some embodiments, the ammonia gas is ammonia vapor. In some embodiments, the water is purified water such as deionized water. In further embodiments, the metal oxide is granular.

Embodiments of the present invention further provide processes in which the time required to treat a sample with ammonia vapor is less than the time required to treat a sample using a conventional method employing liquid ammonia. As used herein,

Embodiments of the present invention also provide processes in which the amount of water used in the washing processes described herein is less than the amount of water used in a washing process of a conventional method employing liquid ammonia.

Embodiments of the present invention further provide gold metal oxide catalysts synthesized by the processes described herein.

Embodiments of the present invention further provide processes for the oxidation of carbon monoxide including introducing a gold metal oxide catalyst synthesized by the processes described herein to an environment including carbon monoxide under conditions suitable to support the substantial conversion of carbon monoxide to carbon dioxide. The catalysts are contemplated as having utility for applications including, but not limited to, gas masks, fuel cells and carbon dioxide lasers.

Embodiments of the present invention will be further explained with reference to the following example, which is included herein for illustration purposes only, and which is not intended to be limiting of the invention.

### EXAMPLE

### Process for the Synthesis of a Gold Metal Oxide Catalyst

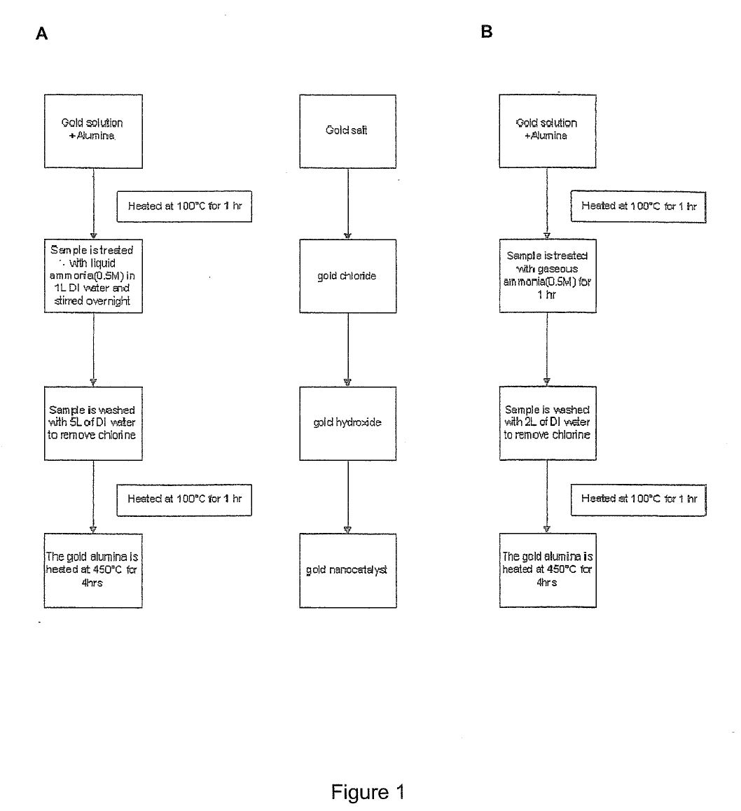

A sample was prepared by taking 5 g of aluminum oxide of particle size 18 mesh and adding to the aluminum oxide, 0.2 g of gold salt (HAuCl₄) in 1 g of deionized (DI) water. The sample was kept in the oven at about 100° C. for a period of about 2 hours to ensure that moisture was vaporized. 20 ml of 0.5M ammonia solution was kept in a desiccator. The sample was taken from the oven to the desiccator where the gold salt was reduced to gold hydroxide in the presence of ammonia vapor. The sample was kept in the desiccator overnight to ensure reduction of the gold salt. The sample was washed in DI water to remove the chlorine. Washing was repeated several times and the water, which had been used for washing, was tested in the presence of silver nitrate for the precipitation of chlorine. The sample was kept in the oven at about 100° C. for a period of 2 hours to ensure that moisture was vaporized. The sample was kept at about 450° C. for about 4 hours to complete conversion of gold hydroxide to gold catalyst. FIG. 1B provides a flow chart presenting a method of forming a gold metal oxide catalyst as described herein.

Initial data provides 20% conversion of carbon monoxide to carbon dioxide when 5% carbon monoxide and 95% balanced air was used as a sample gas.

The foregoing is illustrative of the present invention, and is not to be construed as limiting thereof. The invention is defined by the following claims, with equivalents of the claims to be included therein.

That which is claimed is:

1. A process for the synthesis of a gold metal oxide catalyst, the process comprising:
(a) evaporating moisture from a mixture comprising a metal oxide and a solution of a gold salt;
(b) reducing the gold salt of (a) to gold hydroxide in the presence of ammonia gas to provide a reduced product;
(c) washing the product remaining after (b) with water; and
(d) evaporating moisture from the product remaining after (c) to provide a gold metal oxide catalyst.

2. The process of claim 1, wherein the metal oxide is aluminum oxide, silicon oxide, magnesium oxide, titanium oxide or combinations thereof.

3. The process of claim 1, wherein the metal oxide is aluminum oxide.

4. The process of claim 1, wherein the metal oxide is granular.

5. The process of claim 1, wherein the water is deionized water.

6. The process of claim 1, wherein the ammonia gas is a vapor.

7. The process of claim 1, wherein the time required to treat a sample with ammonia vapor is less than the time required to treat a sample using a conventional method employing liquid ammonia.

8. The process of claim 1, wherein the amount of water used in the washing process of (c) is less than the amount of water used in a washing process of a conventional method employing liquid ammonia.

9. A gold metal oxide catalyst synthesized by the process of claim 1.
